(19) United States
(12) Patent Application Publication
(10) Pub. No.: US 2007/0032189 A1
(43) Pub. Date: Feb. 8, 2007

(54) Apparatus and method for wirelessly transmitting image signal to outside

(75) Inventor: Yong-Bon Park, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/498,654

(22) Filed: Aug. 3, 2006

(30) Foreign Application Priority Data
Aug. 3, 2005 (KR) 2005-70932

(51) Int. Cl. H04H 7/00

(52) U.S. Cl. 455/3.06

(57) ABSTRACT

An apparatus for receiving an image signal for reproduction from a multimedia device, which includes an interface for outputting the image signal for reproduction to the outside, and wirelessly transmitting the image signal to the outside includes: an interface unit, which is combined with the multimedia device via the interface of the multimedia device and then receiving the image signal for reproduction; and a Radio Frequency (RF) transmitter for wirelessly transmitting the image signal, which has been received via the interface unit, using a predetermined channel of an Ultra High Frequency (UHF) band. A method of transmitting an image signal to an image device, which receives the image signal transmitted using a channel of a UHF band and displays an image corresponding to the image signal, includes the steps of: receiving an image signal for reproduction from a multimedia device for outputting the image signal for reproduction to the outside by being combined with the multimedia device; and wirelessly transmitting the received image signal via a predetermined channel of the UHF band.

### PRIORITY

This application claims priority under 35 U.S.C. § 119 to an application entitled “Apparatus and Method for Transmitting Image Signal to Outside by Radio” filed in the Korean Intellectual Property Office on Aug. 3, 2005 and assigned Serial. No. 2005-70932, the contents of which are incorporated herein by reference.

### BACKGROUND OF THE INVENTION

1. Field of the Invention

The present invention relates generally to an apparatus and method for receiving an image signal for reproduction from a multimedia device, which includes an interface for outputting the image signal to the outside, and wirelessly transmitting the image signal to the outside.

2. Description of the Related Art

A representative example of a function of outputting an image signal for reproduction to the outside is a TV-OUT function. The TV-OUT function is one of main functions employed by multimedia devices such as mobile phones, multimedia players, computers, and digital multimedia broadcasting (DMB) receivers and is a function of outputting an image signal for reproduction to a TV. Demands for the TV-OUT function is growing with the accompanying high quality of images which can be reproduced by mobile terminals, improvement of wireless transmission rate, and the coming of DMB.

However, to use the TV-OUT function, cable for transmitting an image signal is directly connected from a multimedia device to a video input terminal of a TV. Thus, the surroundings are messy due to the cable wiring, and the TV-OUT function cannot be used for TVs that do not have the video input terminal.

Unlike the TV-OUT function, a 2.4 GHz-band wireless transmission method is used in industrial sites as a function of wirelessly transmitting an image signal. However, the 2.4 GHz-band wireless transmission method requires an exclusive transmitter and an exclusive receiver.

### SUMMARY OF THE INVENTION

An object of the present invention is to provide a solution at least to the above problems and/or disadvantages and to provide at least the advantages set forth below. Accordingly, an object of the present invention is to provide an apparatus and method for receiving an image signal for reproduction from a multimedia device, which includes an interface for outputting the image signal for reproduction to the outside, and wirelessly transmitting the image signal to the outside.

According to one aspect of the present invention, there is provided an apparatus for transmitting an image signal to an image device, which receives the image signal transmitted using a channel of an Ultra High Frequency (UHF) band and displays an image corresponding to the image signal, the apparatus having a multimedia device including an interface for outputting an image signal for reproduction to the outside; and a wireless transmission apparatus, which is combined with the multimedia device via the interface and then receives the image signal for reproduction and wirelessly transmits the image signal for reproduction via a predetermined channel of the UHF band.

According to another aspect of the present invention, there is provided an apparatus for receiving an image signal for reproduction from a multimedia device, which includes an interface for outputting the image signal for reproduction to the outside, and wirelessly transmitting the image signal to the outside, the apparatus having: an interface unit, which is combined with the multimedia device via the interface of the multimedia device and then receiving the image signal for reproduction; and a Radio Frequency (RF) transmitter for wirelessly transmitting the image signal, which has been received via the interface unit, using a predetermined channel of aUHF band.

According to another aspect of the present invention, there is provided a method of transmitting an image signal to an image device, which receives the image signal transmitted using a channel of aUHF band and displays an image corresponding to the image signal, the method including the steps of: receiving an image signal for reproduction from a multimedia device for outputting the image signal for reproduction to the outside by being combined with the multimedia device; and wirelessly transmitting the received image signal via a predetermined channel of the UHF band.

### BRIEF DESCRIPTION OF THE DRAWINGS

The above and other objects, features and advantages of the present invention will become more apparent from the following detailed description when taken in conjunction with the accompanying drawings, in which:

FIG. 1 is a configuration for explaining a process for a wireless transmission apparatus to be combined with a multimedia device and wirelessly transmits an image signal to an image device, according to the present invention;

FIG. 2 is a block diagram illustrating a wireless transmission apparatus according to the present invention; and

FIG. 3 is a flowchart illustrating a method of wirelessly transmitting an image signal from a wireless transmission apparatus combined with a multimedia device to an image device, according to the present invention.

### DETAILED DESCRIPTION OF THE PREFERRED EMBODIMENT

Preferred embodiments of the present invention will be described herein below with reference to the accompanying drawings. In the drawings, the same or similar elements are denoted by the same reference numerals even though they are depicted in different drawings. In the following description, well-known functions or constructions are not described in detail since they would obscure the invention in unnecessary detail.

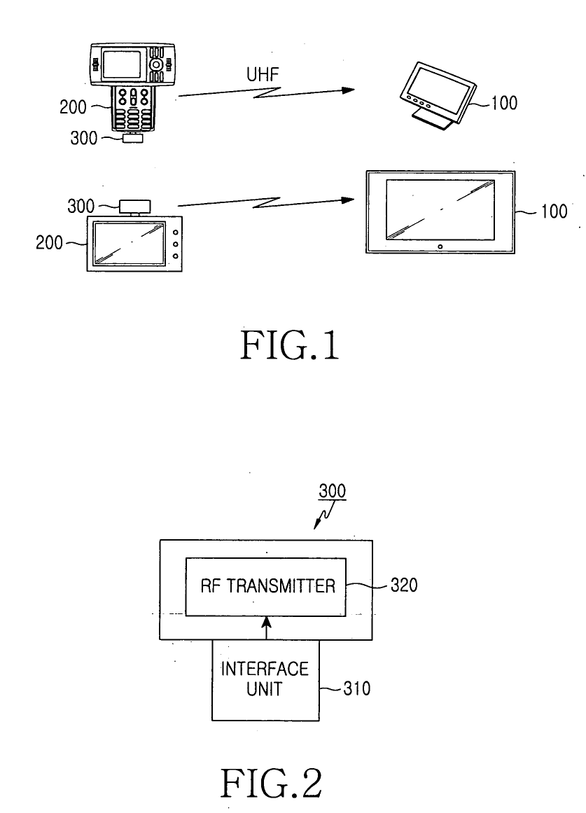

FIG. 1 is a configuration for explaining a process for a wireless transmission apparatus 300 to be combined with a multimedia device 200 and wirelessly transmit an image signal to an image device 100, according to the present invention.

Referring to FIG. 1, the image device 100, e.g., a car TV or home TV, receives an image signal transmitted using a channel of an Ultra High Frequency (UHF) band 300-3000 MHz and displays an image corresponding to the image signal. The multimedia device 200 is a device for outputting an image signal for reproduction to the outside, e.g., a mobile phone having a TV-OUT function, a multimedia player, a computer, or a DMB receiver. The multimedia device 200 includes an interface for the TV-OUT function and outputs the image signal for reproduction to the wireless transmission apparatus 300 via the interface.

The wireless transmission apparatus 300 according to the present invention is combined with the multimedia device 200 via the interface for the TV-OUT function, which is included in the multimedia device 200, and then receives the image signal for reproduction and wirelessly transmits the image signal using a predetermined channel of the UHF band. The image device 100 can receive an RF signal from the wireless transmission apparatus 300 within a distance of 3 m, and the wireless transmission apparatus 300 wirelessly transmits the image signal by selecting the predetermined channel using extremely low power radio, which can be used without notice. The image device 100 selects the predetermined channel to receive the image signal wirelessly transmitted via the predetermined channel from the wireless transmission apparatus 300.

FIG. 2 is a block diagram schematically illustrating of the wireless transmission apparatus 300 according to the present invention.

Referring to FIG. 2, an interface unit 310 of the wireless transmission apparatus 300 is combined with the multimedia device 200 via the interface for the TV-OUT function, which is included in the multimedia device 200, and then receives the image signal for reproduction and outputs the image signal to a Radio Frequency (RF) transmitter 320. The image signal includes an audio signal and a video signal. That is, the interface unit 310 receives the audio signal and the video signal via signal transmission lines of the interface for the TV-OUT function, which is included in the multimedia device 200, and outputs the audio signal and the video signal to the RF transmitter 320.

If the interface for the TV-OUT function, which is included in the multimedia device 200, has transmission lines for supplying power, the wireless transmission apparatus 300 receives power from the multimedia device 200 via the interface unit 310. If the wireless transmission apparatus 300 is combined with the multimedia device 200 via the interface for the TV-OUT function, the multimedia device 200 supplies power to the wireless transmission apparatus 300 via the power transmission lines of the interface for the TV-OUT function. Even if the interface for the TV-OUT function, which is included in the multimedia device 200, does not have the transmission lines for supplying power, the wireless transmission apparatus 300 may supply internal power by including a self power supply.

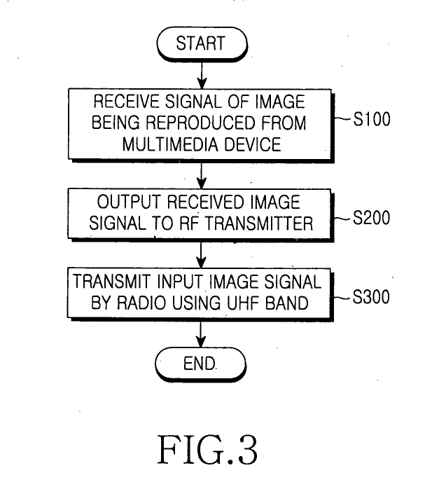

The RF transmitter 320 wirelessly transmits the image signal input via the interface unit 310 using a predetermined channel of the UHF band . The image signal wirelessly transmitted using the predetermined channel of the UHF band from the RF transmitter 320 is received by the image device 100, which has selected the predetermined channel, and the image device 100 displays an image corresponding to the received image signal. A process for the wireless transmission apparatus 300 according to the present invention to be combined with the multimedia device 200 and wirelessly transmit an image signal to the image device 100 will now be described in detail below with reference to FIG. 3.

FIG. 3 is a flowchart illustrating a method of wirelessly transmitting an image signal from the wireless transmission apparatus 300 combined with the multimedia device 200 to the image device 100, according to the present invention.

When a user of the wireless transmission apparatus 300 wants to watch an image reproduced by the multimedia device 200, such as a mobile phone having a TV-OUT function, a multimedia player, a computer, or a DMB receiver, using the image device 100 such as a TV, the user activates the TV-OUT function of the multimedia device 200 and combines the interface unit 310 of the wireless transmission apparatus 300 with the interface for the TV-OUT function, which is included in the multimedia device 200. Then, the wireless transmission apparatus 300 is combined with the multimedia device 200, and the multimedia device 200 outputs a signal of an mage being reproduced therein to the combined wireless transmission apparatus 300 via the interface for the TV-OUT function.

In step S100, the interface unit 310 of the wireless transmission apparatus 300 combined with the interface for the TV-OUT function, which is included in the multimedia device 200, receives the signal of the mage being reproduced in the multimedia device 200 from the multimedia device 200. In step S200, the interface unit 310 outputs the received image signal to the RF transmitter 320. The image signal includes an audio signal and a video signal. If the interface for the TV-OUT function, which is included in the multimedia device 200, has transmission lines for supplying power, the wireless transmission apparatus 300 receives power from the multimedia device 200 via the interface unit 310. If the wireless transmission apparatus 300 is combined with the multimedia device 200 via the interface for the TV-OUT function, the multimedia device 200 supplies power to the wireless transmission apparatus 300 via the power transmission lines of the interface for the TV-OUT function. Even if the interface for the TV-OUT function, which is included in the multimedia device 200, does not have the transmission lines for supplying power, the wireless transmission apparatus 300 may supply internal power by including a self power supply.

In step S300, the RF transmitter 320 of the wireless transmission apparatus 300, which has input the image signal via the interface unit 310, wirelessly transmits the input image signal using a predetermined channel of the UHF band. The image signal wirelessly transmitted using the predetermined channel of the UHF band from the RF transmitter 320 is received by the image device 100, which has selected the predetermined channel, and the image device 100 displays an image corresponding to the received image signal.

As described above, according to the present invention, by wirelessly transmitting an image signal according to a TV-OUT function using the UHF band, a problem of messy surroundings due to cable wiring can be solved.

In addition, by applying the invention to a car TV having poor image quality due to a low broadcasting signal reception ratio, an image having good image quality can be provided.

In addition, by applying the invention to a TV, which does not have a video input terminal, the TV-OUT function can be used.

In addition, by receiving power for operation from a multimedia device, a separate power supply does not have to be included.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. An apparatus for transmitting an image signal to an image device, which receives the image signal transmitted using a channel of an Ultra High Frequency (UHF) band and displays an image corresponding to the image signal, the apparatus comprising:
a multimedia device including an interface for outputting the image signal for reproduction; and
a wireless transmission apparatus, which is combined with the multimedia device via the interface, which receives the image signal for reproduction and wirelessly transmits the image signal for reproduction via a predetermined channel of the UHF band.

2. The apparatus of claim 1, wherein the multimedia device is one of a mobile phone, a multimedia player, a computer, and a digital multimedia broadcasting (DMB) receiver.

3. The apparatus of claim 1, wherein the image device is a television.

4. The apparatus of claim 1, wherein the image device selects the predetermined channel to receive the image signal wirelessly transmitted from the wireless transmission apparatus.

5. The apparatus of claim 1, wherein the wireless transmission apparatus receives power via the interface of the multimedia device.

6. The apparatus of claim 1, wherein the multimedia device supplies power to the wireless transmission apparatus via the interface if the wireless transmission apparatus is combined with the multimedia device via the interface.

7. The apparatus of claim 1, wherein the wireless transmission apparatus receives power from a self power supply.

8. The apparatus of claim 1, wherein the image signal comprises an audio signal and a video signal.

9. An apparatus for receiving an image signal for reproduction from a multimedia device, which includes an interface for outputting the image signal for reproduction to the outside, and wirelessly transmitting the image signal, the apparatus comprising:
the interface unit, which is combined with the multimedia device via the interface of the multimedia device, and which receives the image signal for reproduction; and
a Radio Frequency (RF) transmitter for wirelessly transmitting the image signal, which has been received via the interface unit using a predetermined channel of an Ultra High Frequency (UHF) band.

10. The apparatus of claim 9, wherein the interface unit receives power from the multimedia device.

11. The apparatus of claim 9, further comprising a self power supply for supplying internal power.

12. A method of transmitting an image signal to an image device, which receives the image signal transmitted using a channel of an Ultra High Frequency (UHF) band and displays an image corresponding to the image signal, the method comprising the steps of:
receiving an image signal for reproduction from a multimedia device for outputting the image signal for reproduction by being combined with the multimedia device; and
wirelessly transmitting the received image signal via a predetermined channel of the UHF band.

13. The method of claim 12, wherein the multimedia device is one of a mobile phone, a multimedia player, a computer, and a digital multimedia broadcasting (DMB) receiver.

14. The method of claim 12, wherein the image device is a television.

15. The method of claim 12, wherein the image device selects the predetermined channel to receive the image signal wirelessly transmitted.

16. The method of claim 12, further comprising receiving power from the multimedia device.

17. The method of claim 12, further comprising receiving power from a self power supply.

18. The method of claim 12, wherein the image signal comprises an audio signal and a video signal.
